(19) United States
(12) Patent Application Publication
(10) Pub. No.: US 2025/0242990 A1
(43) Pub. Date: Jul. 31, 2025

(54) A Storage Box and Storage Box System

(71) Applicant: TRED Outdoors Pty Ltd, Margate Beach (AU)

(72) Inventors: Christopher Roberts; Mayer Jung; Aiden Thomlinson

(21) Appl. No.: 18/686,335

(22) PCT Filed: Aug. 25, 2022
(86) PCT No.: PCT/AU2022/051025

§ 371 Date: Mar. 7, 2024

(30) Foreign Application Priority Data
Aug. 25, 2021 (AU) 2021221680

(51) Int. Cl. B65D 81/38; B65D 21/02; B65D 25/04; B65D 25/18; B65D 43/02; B65D 45/20; F25D 3/10

(52) U.S. Cl. CPC B65D 81/3818; B65D 21/0204; B65D 21/0219; B65D 25/04; B65D 25/18; B65D 43/0202; B65D 45/20; F25D 3/10; F25D 2303/081; F25D 2303/083

(57) ABSTRACT

A storage box and storage box system that has connectors to connect horizontally and vertically adjacent storage boxes. A lid of the boxes is releasably retained to the body via hinge members that selectively hinge the lid such that the lid can be opened from different sides of the body Furthermore, the lid can be removed entirely, should it be desired, by unlocking all hinge members. The storage boxes can have a liner to provide thermal insulation.

### FIELD OF THE INVENTION

The invention relates to a storage box and storage box system. In particular, the invention preferably relates, but is not limited, to an insulated cooler box and cooler box connection system where two or more cooler boxes can be connected vertically (side by side) and/or horizontally (stacked).

### BACKGROUND TO THE INVENTION

Reference to background art herein is not to be construed as an admission that such art constitutes common general knowledge.

Storage boxes come in all manner of shapes and sizes. Most are used for general storage and transportation but some are insulated. Insulated storage boxes, commonly known as a cooler box, ice box, Esky (in Australia), or Chilly-bin (in New Zealand), are typically used to store and transport food and drinks. In some cases, the cooler box may be actively cooled (refrigerated) or even heated depending on its use. Sometimes it may be preferred to use a cooler box as a general storage box for articles not requiring insulation of a temperature differential. In such cases a cooler box has limited space due to the thickness of the insulating walls.

Storage boxes are also typically standalone articles which are moved, stored, stacked, independently from one another. During transportation and use each box can move independently. A ratchet strap, or the like, may be used to hold multiple boxes together. Such a strap may be difficult to arrange, come loose, or catch loose objects. Furthermore, if the strap extends vertically around stacked boxes it prohibits opening of the boxes and the strap must be removed before use. Additionally, articles contained therein are often loose and can be damaged or broken.

### OBJECT OF THE INVENTION

It is an aim of this invention to provide a storage box and storage box system which overcomes or ameliorates one or more of the disadvantages or problems described above, or which at least provides a useful alternative.

Other preferred objects of the present invention will become apparent from the following description.

### SUMMARY OF THE INVENTION

In one form, although it need not be the only or indeed the broadest form, there is provided a storage box comprising: a body defining a cavity for storage of articles therein; at least one lid configured to selectively allow access to the cavity of the body; one or more first connectors configured to connect to a horizontally adjacent storage box; and one or more second connectors configured to connect to a vertically adjacent storage box.

In another form, there is provided a storage box system comprising: a plurality of storage boxes, each storage box having a body defining a cavity for storage of articles therein; and a lid that selectively allows access to the cavity; wherein at last a first storage box of the plurality of storage boxes comprises: at least one first connector configured to connect to a second storage box of the plurality of storage boxes located horizontally adjacent the first storage box; and at least one second connector configured to connect a third storage box of the plurality of storage boxes located vertically adjacent the first storage box.

The body may comprise four walls and a floor. The walls of the body may be tapered. The body may be of a unitary construction. Preferably the body is made of a plastic material. The body may be formed from injection moulded plastic. The lid may be of a unitary construction. Preferably the lid is made of a plastic material. The lid may be formed from injection moulded plastic. The one or more first and/or second connectors may be located on the lid. Alternatively, or additionally, the one or more first and/or second connectors may be located on the body.

The storage box may further comprise a fascia. The fascia may be located around an opening to the cavity in the body. The fascia may comprise one or more apertures. The apertures may be configured to receive one or more of a strap, rope, or webbing. The fascia may be mounted to the body. The fascia may be located between the body and the lid.

The one or more first and/or second connectors preferably comprise a latch and a catch. In a form, the catch may comprise a recess configured to receive and operatively connect the latch. The recess may comprise a main recess and a pocket. The latch may comprise a latch member and a protrusion. The main recess of the catch is preferably configured to receive the latch member and the pocket is preferably configured to receive the protrusion of the latch. The latch may comprise one or more resiliently flexible portions. The protrusion may be located on the one or more resiliently flexible portions. The latch may be configured to pivot with respect to the body. The latch may be configured to pivot around operatively connected protrusion and pockets of the storage recess located at an opposite end of the latch member to its free end. At least one of the lugs may be located on a resiliently flexible portion of the latch.

The latch may be configured to be retained in a storage recess of one box and selectively pivoted out to connect with the catch of an adjacent box where it is releasably retained. Each connector may comprise a pair of adjacent catches with a single latch located within one of the catches. When a further storage box is located horizontally adjacent a first storage box, the catches of each box may align. The latch of the first storage box may be released from its own catch and pivoted into the empty catch of the further storage box. The latch of the further storage box may be pivoted from its own catch into the empty catch of the first storage box. Adjacent storage boxes are thereby connected by two latches.

In another form, the catch may comprise a rib configured to be captured by the latch. The rib may be located on the body. The rib may be located at or adjacent the floor of the body. The latch may comprise a hook adapted to grasp the rib. The first and second connectors may be of different forms. In a preferred embodiment, the first connectors may comprise the catch may comprise the form having a recess configured to receive and operatively connect the latch and the second connectors may comprise the form having a rib configured to be captured by the latch.

The lid may be hinged to the body. The lid may be hinged to the body via a hinge member. The hinge member may be permanently located on the body and selectively connected to the lid. The lid may be selectively hinged to at least two sides of the body. At least one hinge member may be provided on opposed sides of the body. In a preferred form, two hinge members are provided on each opposed side of the body. The hinge members may comprise a fixed end and a free end. The hinge members may be pivotable between a locked position and an unlocked position.

The hinge members may comprise an arm and a gate. The gate may be transverse to the arm. The gate may be substantially perpendicular to the arm. In the locked position the gate of the hinge members may retain a pin of the lid in a seat of the body. In the unlocked position the gate of the hinge member may allow the pin of the lid to pass such that it can be released from its seat. The pin and/or seat may be semi-circular. The pin and seat preferably provide a pivot point for the lid when the pin is retained in the seat by the hinge member in the locked position.

The body may further comprise a liner. The liner is preferably configured to be received into the cavity of the body. The liner may be removable. When in use, the liner is preferably spaced apart from the walls of the body separating the cavity into an inner portion of the cavity located within the liner and an outer portion of the cavity located between the liner and the body. The outer portion of the cavity is preferably in the form of an air-gap between the walls of the body and the liner. The liner may have a lip. The liner is preferably configured to rest upon an edge of the walls of the body adjacent an opening of the cavity. An insulating material may be provided in the outer portion of the cavity between the liner and the body.

The liner may comprise one or more grooves. The one or more grooves are preferably configured to receive one or more dividing members. The dividing members may be configured to segment an internal space defined by the liner. The dividing members may be in the form of chopping boards. The storage box may comprise one or more storage trays. The storage trays may be suspended in the liner.

The body may comprise one or more anchoring members in the cavity. The one or more anchoring members may be located on an inner side of the floor. The inner side of the floor may comprise one or more plinths to which the anchoring members may be mounted.

The body may comprise one or more feet. The feet are preferably located adjacent the floor. The feet may comprise an elastomeric material. The feet may be made of TPU. The feet may be attached to the body. The feet are preferably located in corners of the body. The feet may be located in alcove of the body. The feet may friction fit with the body. The feet may be removable. The feet preferably provide non-slip members configured to engage with a surface upon which the box is placed.

A drainage system may be provided in the body. The drainage system may be located in one of the walls of the body. The drainage system may comprise a drainage hole. The drainage hole may be located in a wall of the body. The drainage system may comprise a drainage sleeve. The drainage system may comprise a bung. The drainage system may comprise one or more seals. The drainage system may comprise a screw cap. The bung is preferably threaded. The drainage sleeve preferably fluidly connects the inner portion of the cavity to the drainage hole in the body. The drainage sleeve may be removable.

In another form, there is provided a storage box comprising: a body having walls and a floor collectively defining a cavity; a liner mountable within the cavity of the body; and at least one lid; wherein the lid is configured to selectively allow access to contents contained with the storage box from either side of the body and wherein the liner is removable and configured to split the cavity of the body into an inner cavity located inside the liner for storage of articles and an outer cavity located between the liner and the walls and floor of the body when it is located therein.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a perspective view of a storage box;

FIG. 2 illustrates an exploded perspective view of the storage box of FIG. 1;

FIG. 3 illustrates a perspective view of another storage box;

FIG. 4 illustrates an exploded perspective view of the storage box of FIG. 3;

FIG. 5 illustrates a cross-sectional view of the storage box of FIG. 3 in a closed position with locked latches;

FIG. 5A is a closeup of region ‘A’ of FIG. 5,

FIG. 6 illustrates a cross-sectional view of the storage box of FIG. 3 in a closed position with the right side latches unlocked;

FIG. 6A illustrates a closeup view of region ‘A’ of FIG. 6;

FIG. 6B illustrates a closeup view of region ‘B’ of FIG. 6;

FIG. 7 illustrates a cross-sectional view of the storage box of FIG. 3 in an open position using the left side latches as a hinge;

FIG. 7A illustrates a closeup view of region ‘A’ of FIG. 7;

FIG. 7B illustrates a closeup view of region ‘B’ of FIG. 7;

FIG. 8 illustrates a cross-sectional view of the storage box of FIG. 3 in an open position using the right side latches as a hinge;

FIG. 8A illustrates a closeup view of region ‘A’ of FIG. 8;

FIG. 8B illustrates a closeup view of region ‘B’ of FIG. 8;

FIG. 9 illustrates a perspective view of two horizontally aligned storage boxes;

FIG. 10 illustrates a side cross-sectional view of the two horizontally aligned storage boxes of FIG. 9;

FIG. 10A illustrates a closeup view of region ‘A’ of FIG. 10;

FIG. 11 illustrates a perspective view of two horizontally connected storage boxes;

FIG. 12 illustrates a side cross-sectional view of the two horizontally connected storage boxes of FIG. 11;

FIG. 12A illustrates a closeup view of region ‘A’ of FIG. 12;

FIG. 13 illustrates a perspective view of two vertically aligned storage boxes;

FIG. 14 illustrates a side cross-sectional view of the two vertically aligned storage boxes of FIG. 13;

FIG. 14A illustrates a closeup view of region ‘A’ of FIG. 14;

FIG. 15 illustrates a perspective view of two vertically stacked storage boxes;

FIG. 16 illustrates a side cross-sectional view of the two vertically stacked storage boxes of FIG. 15;

FIG. 16A illustrates a closeup view of region ‘A’ of FIG. 16;

FIG. 17 illustrates a perspective view of two vertically connected storage boxes;

FIG. 18 illustrates a side cross-sectional view of the two vertically connected storage boxes of FIG. 17;

FIG. 18A illustrates a closeup view of region ‘A’ of FIG. 18;

FIG. 19 illustrates a top perspective view of the inside of a storage box having anchoring members located on its floor;

FIG. 20 illustrates a perspective view of a storage box connected to a wheel accessory;

FIG. 21 illustrates a perspective view of another storage box;

FIG. 22 illustrates an exploded perspective view of the storage box of FIG. 21;

FIG. 23 illustrates a cross-sectional view of the storage box of FIG. 21 in a closed position with locked latches;

FIG. 23A is a closeup of region ‘A’ of FIG. 23;

FIG. 24 illustrates a cross-sectional view of the storage box of FIG. 21 in a closed position with the right side latches unlocked;

FIG. 24A illustrates a closeup view of region ‘A’ of FIG. 24;

FIG. 24B illustrates a closeup view of region ‘B’ of FIG. 24;

FIG. 25 illustrates a cross-sectional view of the storage box of FIG. 21 in an open position using the left side latches as a hinge;

FIG. 25A illustrates a closeup view of region ‘A’ of FIG. 25;

FIG. 25B illustrates a closeup view of region ‘B’ of FIG. 25;

FIG. 26 illustrates a cross-sectional view of the storage box of FIG. 21 in an open position using the right side latches as a hinge;

FIG. 26A illustrates a closeup view of region ‘A’ of FIG. 26;

FIG. 26B illustrates a closeup view of region ‘B’ of FIG. 26;

FIG. 27 illustrates a perspective view of two horizontally aligned storage boxes;

FIG. 28 illustrates a side cross-sectional view of the two horizontally aligned storage boxes of FIG. 27;

FIG. 28A illustrates a closeup view of region ‘A’ of FIG. 28;

FIG. 29 illustrates a perspective view of two horizontally connected storage boxes;

FIG. 30 illustrates a side cross-sectional view of the two horizontally connected storage boxes of FIG. 29;

FIG. 30A illustrates a closeup view of region ‘A’ of FIG. 30;

FIG. 31 illustrates a top perspective view of the inside of a storage box having anchoring members located on its floor; and

FIG. 32 illustrates a closeup view of a connector in a storage position;

FIG. 33 illustrates a closeup view of the connector of FIG. 32 in an upright position;

FIG. 34 illustrates a closeup view of the connector of FIG. 32 in a removed position; and

FIG. 35 illustrates a closeup view of the connector of FIG. 32 connecting two adjacent storage boxes.

### DETAILED DESCRIPTION OF THE DRAWINGS

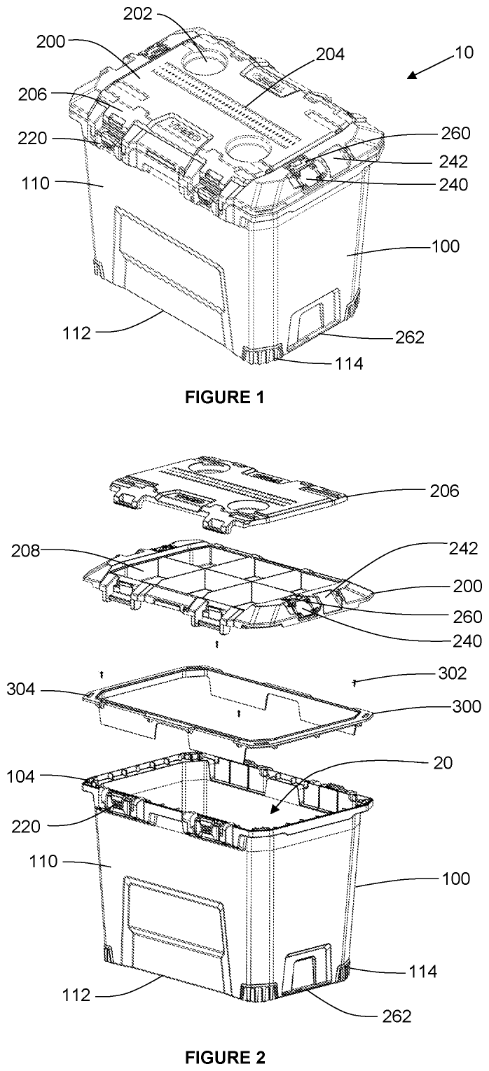

FIG. 1 illustrates a storage box 10 having a body 100 and lid 200. The body 100 has four side walls 110 and a floor 112. The storage box 10 as illustrated is generally rectangular, with the side walls 110 of the body 100 being tapered towards the floor 112, but it will be appreciated that it could take other forms or shapes. The storage box 10 has feet 114 attached to the body 100 which are made of an elastomeric material such as TPU to provide shock absorption and grip to the storage box 10 when it is placed on a surface.

FIG. 2 illustrates an exploded view of the storage box illustrated in FIG. 10. A cavity 20 of the storage box 10 can be seen inside the body 100. A fascia 300 can also be seen, which his mounted to the body 100 via fasteners, such as screw members 302. The fascia provides a tidy reinforced perimeter to the opening of the cavity 20 of the storage box body 100. It also has apertures 304 for ropes, straps, or webbing, or the like, that align with tie-down apertures 104 of the body 100 to provide tie-down points on the box 10.

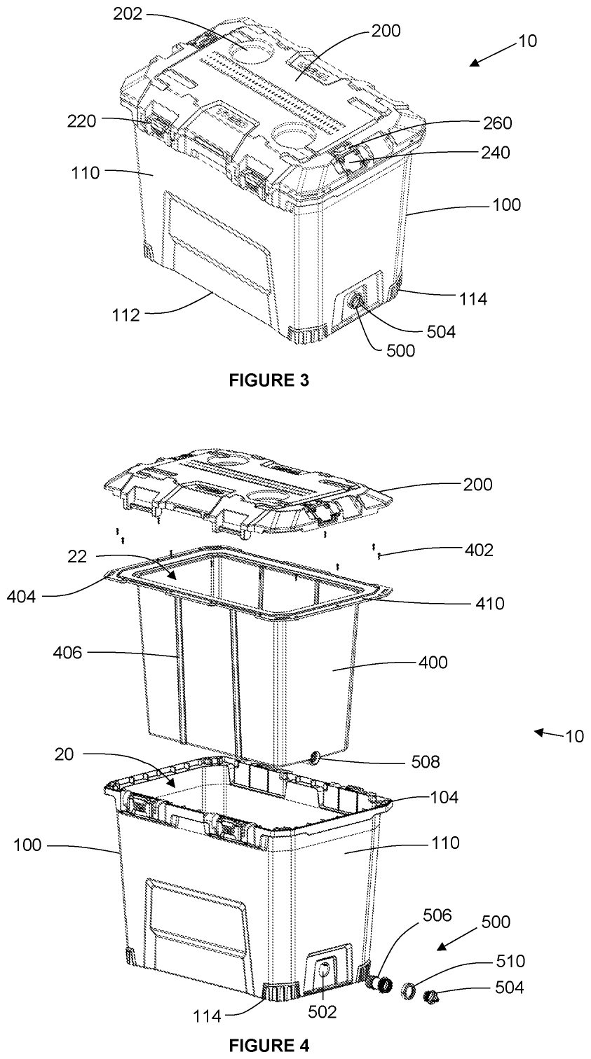

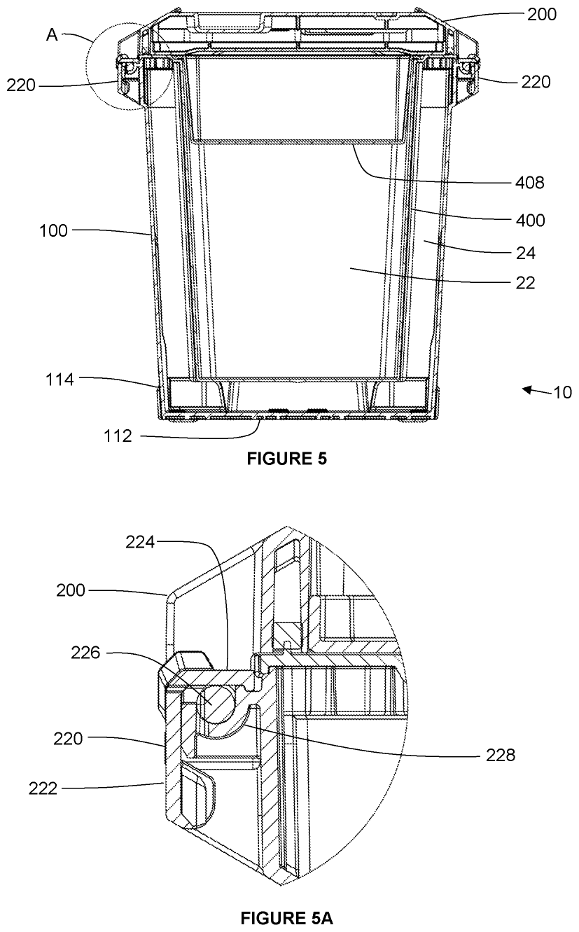

FIGS. 3 and 4 illustrate a similar storage box 10, but instead of a fascia there is provided a liner 400 (see FIG. 4). Like the fascia 300, the liner 400 may be mounted to the body 100 via fasteners, such as screw members 402. The liner 400 is received into the cavity 20 of the body such that it separates the cavity into an inner portion 22 located inside the liner 400 and an outer portion 24 (see FIG. 5) located between the liner 400 and body 100. An insulating material (not shown) may be located in the outer cavity 24 to improve thermal performance. The liner 400 has a lip 410 configured to mate with the body 100 of the storage box 10 and a plurality of grooves 406 which can receive dividers (not shown) or the like. The dividers are preferably multipurpose such that they can be used as chopping boards if desired. One or more storage trays 408 (see FIG. 5) may be suspended to further compartmentalise the storage box 10. The liner 400 also has tie-down apertures 404 for ropes, straps, or webbing, or the like, that align with tie-down apertures 104 of the body 100 to provide tie-down points on the box 10.

The storage box 10 may also comprise a drainage system 500 (not present in FIGS. 1 and 2). The drainage system has a drainage hole 502 in the body 100 of the storage box 10 and a bung 504 to seal the drainage hole 502. Where a liner 400 is provided drainage system 500 can include a drainage sleeve 506 that fluidly connects the inner cavity 22 inside the liner 400, via liner drainage hole 508 to the drainage hole 502. A ring fastener 510 is provided to tighten the sleeve 506 to the drainage hold 502 of the body 100. One or more seals may also be provided to ensure water tightness of the drainage system 500.

The lid 200 in either box comprises a void. In a general purpose storage box form (e.g. FIGS. 1 and 2) access means 206 may be provided to access the void for additional storage. As seen in FIG. 2, the void may be compartmentalised 208. In a thermally insulated ‘cooler’ box form (e.g. FIGS. 3 and 4) thermal insulation material may be provided in the void to assist with insulation and access may not be provided. Alternatively, the void may be accessible via access means 206 for the provision for ice packs, or the like, which may be pre-chilled to allow cool air to flow down from the lid 200 into the cavity 20 (including specifically inner cavity 22 of the liner 400) during use.

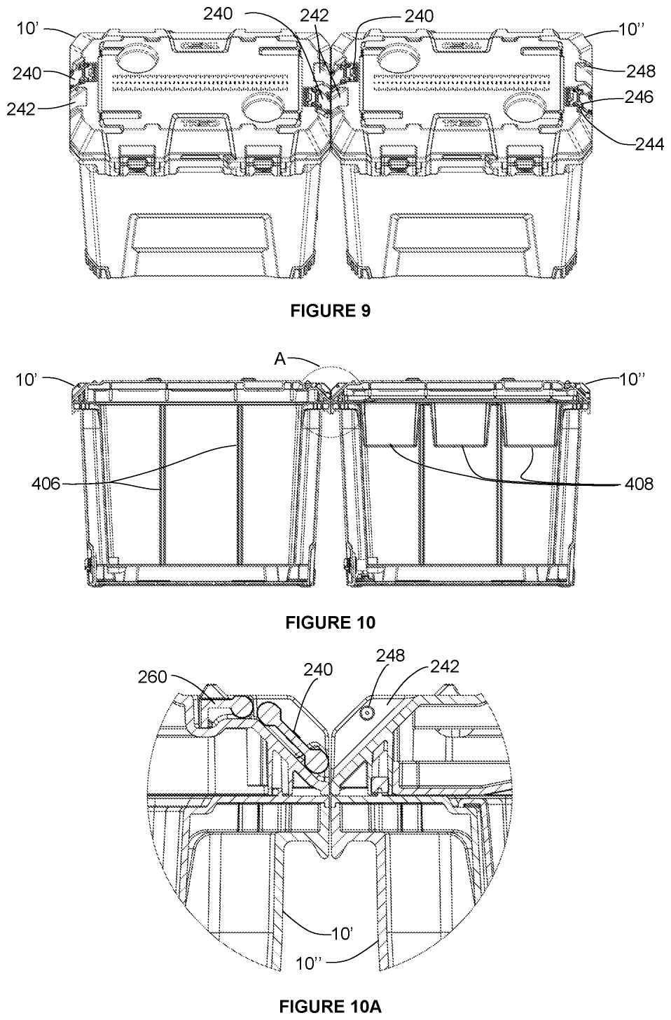

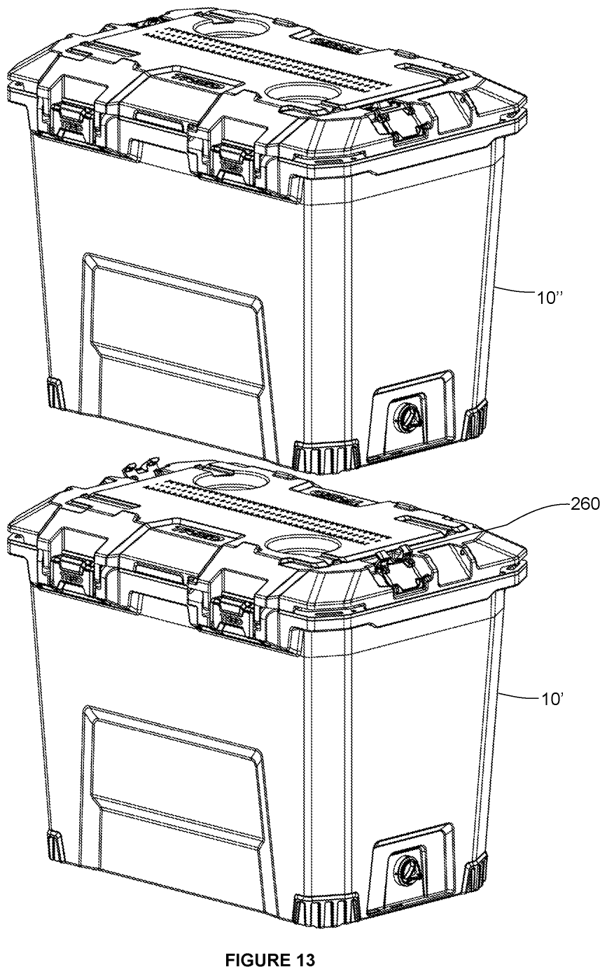

The lid 200 as illustrated has cup/beverage holders 202 and a ruler 204 for convenience. The lid 200 is hingedly connected to the body 100 via hinge members 220. In the illustrated storage box 10 there are four hinge members 220, two on opposed long sides of the body 110. As will be described in greater detail, the hinge members 220 allow the lid to be selectively hinged on each side, such that the lid can be opened from either side as needed (see FIGS. 5 to 8B). Furthermore, the lid 200 can be removed entirely, should it be desired (e.g. for better access or to change type of lid 200), by unlocking all hinge members 220. The lid 200 also has a plurality of first connector members 240 for horizontal connection of storage boxes 10 (see FIGS. 9 to 12A), and second connector members 260 for vertical connection of storage boxes 10 (see FIGS. 13 to 18A).

FIG. 5 illustrates a cross-sectional view of the storage box 10 with lid 200 in a closed and locked position. FIG. 5A illustrates a closeup of region ‘A’ of FIG. 5 showing hinge member 220 in a locked position. Hinge member 220 on the opposite side of the box 10 is similarly in a locked position. Referring specifically to FIG. 5A, it can be seen that hinge member 220 has an arm 222, that is positioned downwards, and a gate 224 that is generally perpendicular to the arm 222. The gate 224 operatively captures a pin 226 of the lid 200 in a seat 228. The seat 228 is semi-circular corresponding to the shape of the pin 226 to allow rotation of the pin 226, and hence the lid 200 if it is otherwise free to do so (which is not the case in FIGS. 5 and 5A) when captured in this position.

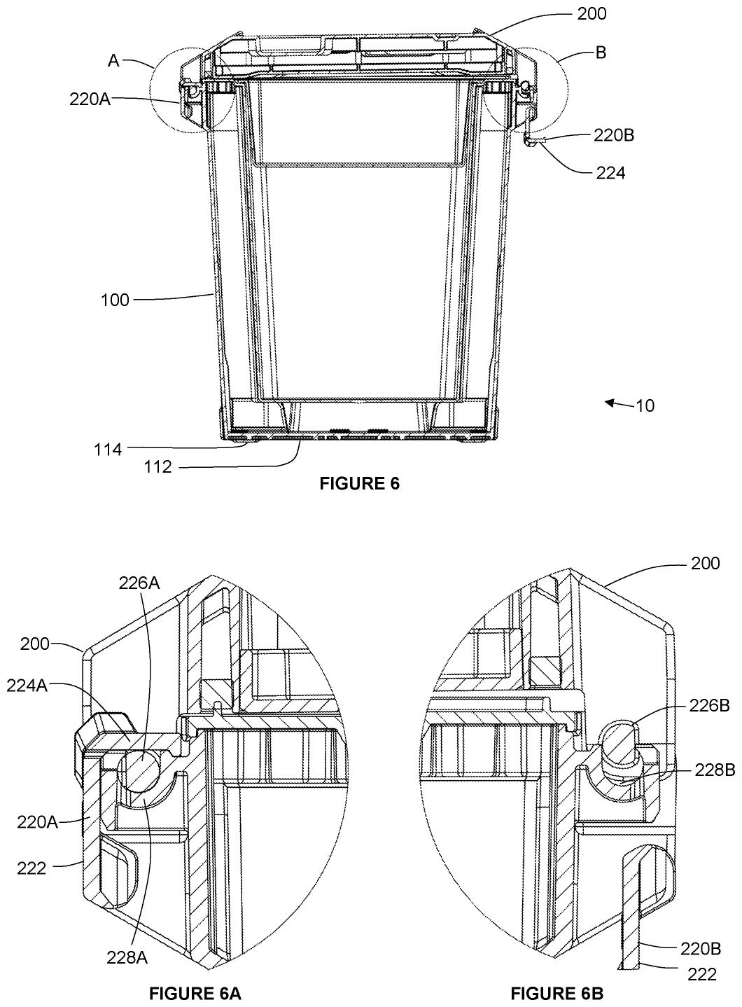

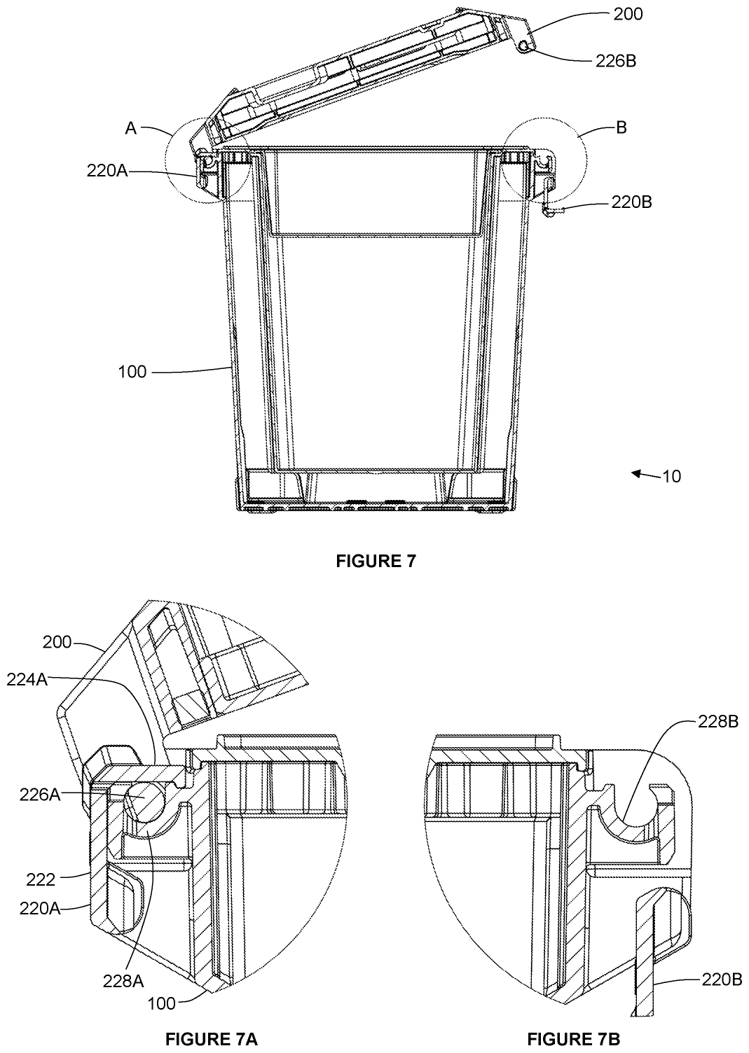

FIGS. 6 to 6B show the same scenario but with the right side hinge member 220B in an unlocked position with the lid 200 being slightly ajar. With the unlocked hinge member 220B out of the way, the right side pin 226B is free to lift out of its seat 228B. This allows the lid 200 to pivot around captured pin 226A retained in seat 228A gate 224A of left side hinge member 220A on the opposite side of the box 10. The lid can be opened in this manner, as shown in FIGS. 7 to 7B.

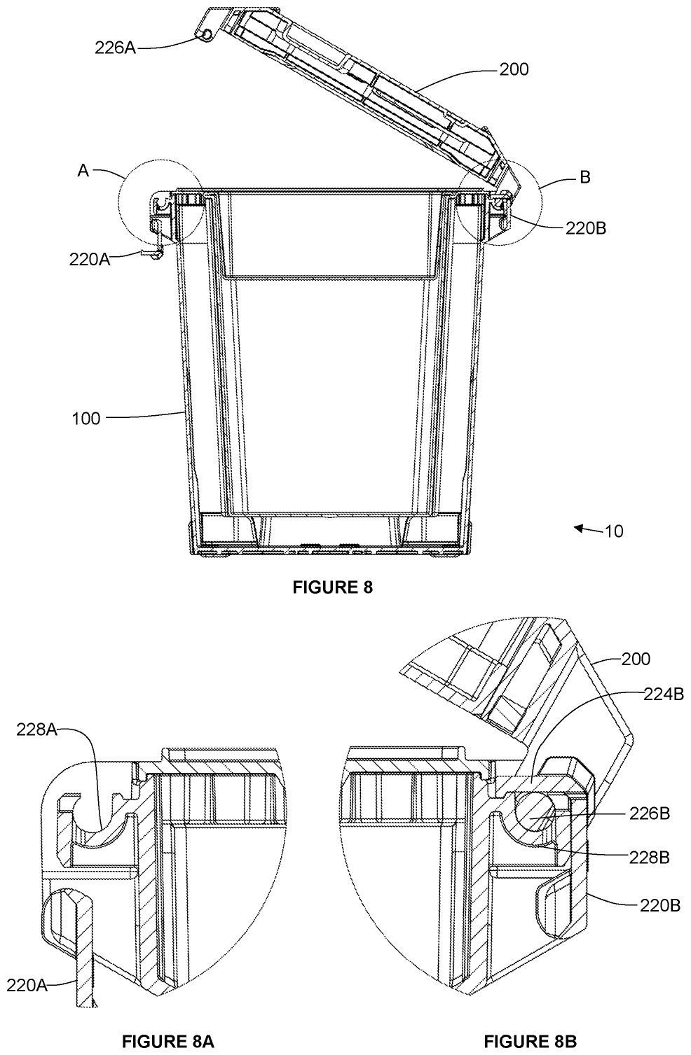

FIGS. 8 to 8B illustrate opening of the lid 200 from the opposite side. In this case, the left side hinge member 220A is unlocked and the right side hinge member 220B is locked with the lid pivoting around its pin 226B captured, and retained in, seat 228B by gate 224B of right side hinge member 220B. As can be appreciated from contrasting FIGS. 7 to 7B with FIGS. 8 to 8B the hinge members 220 allow selective opening of the lid from either side of the box 10. Furthermore, the lid 200 can be removed entirely, should it be desired, by unlocking all hinge members 220.

FIG. 9 shows a first storage box 10′ with a horizontally adjacent second storage box 10″. FIG. 10 illustrates a cross-sectional view of the horizontally aligned storage boxes 10′, 10″ and FIG. 10A illustrates a closeup of region ‘A’ of FIG. 10 showing the first connector member 240 in an unlinked position whereby the adjacent storage boxes 10′, 10″ are independent and unconnected.

In the unlinked position each first connector 240 is in the form of a latch located in a storage recess of the lid 200. Next to each first connector 240 is a recess 242 which aligns with the first connector 240 of the adjacent storage box 10′, 10″. Each first connector 240 has a plurality of protrusions 244, located on resiliently flexible portions 246 of the first connector 240, which correspond to pockets 248 in the recesses 242 of the lid. The recesses 242 with pockets 248 form catches configured to receive and releasably retain the first connector 240.

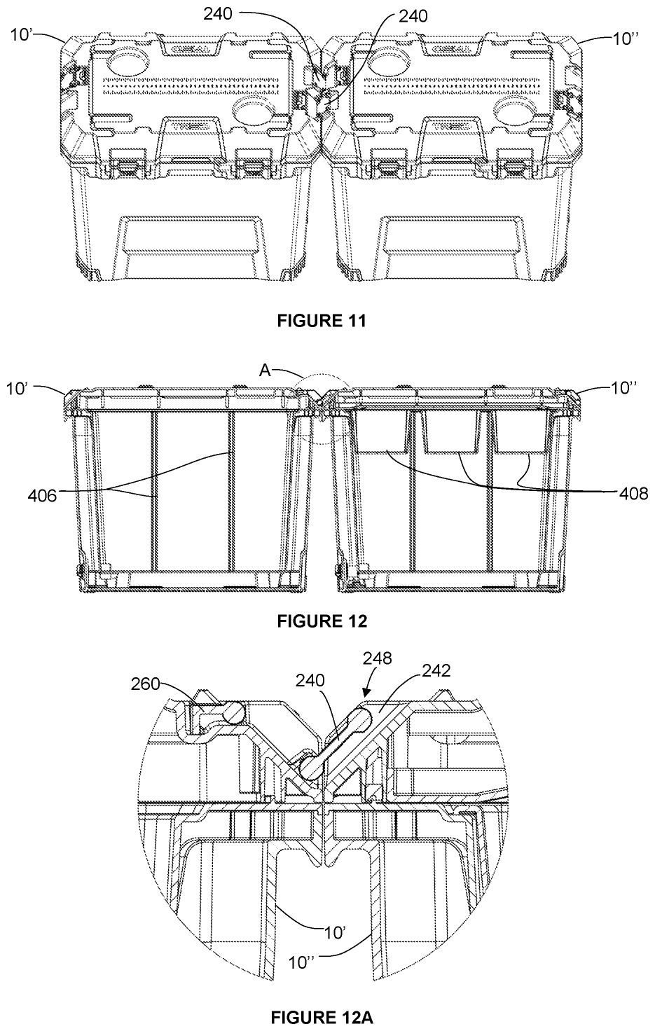

FIGS. 11 to 12A show the storage boxes 10′, 10″ in the same horizontally adjacent locations with their respective connectors 240 flipped over into the corresponding recesses 242 of the adjacent storage box 10′, 10″. The first connector 240 of each box 10′, 10″ is located and retained, in a releasable manner, within the recess 242 of the adjacent box such that the boxes become connected. In this position the protrusion 244 of each first connector 240 is located in the pocket 248 of the adjacent recess 240. The first connector 240 can be released by providing sufficient force for the resiliently flexible portion 246 of the connector to deform sufficiently for the protrusion 244 to escape its pocket 248.

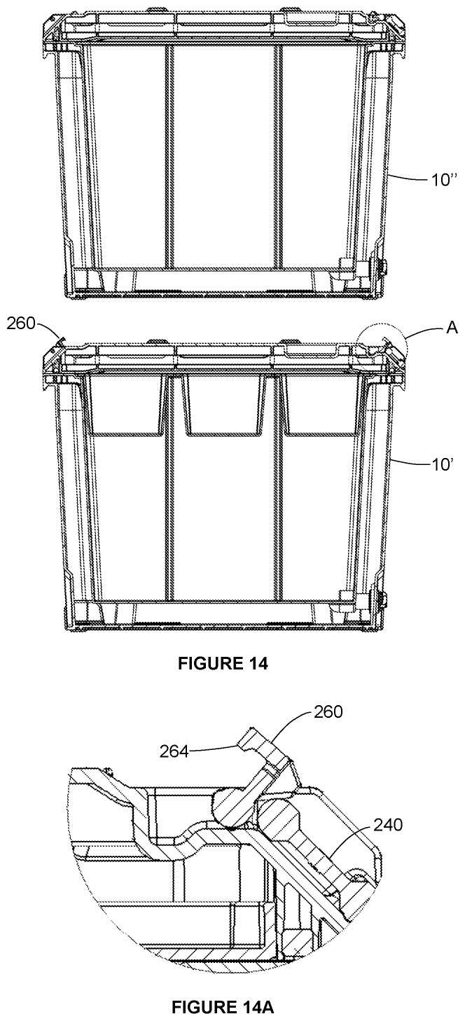

FIG. 13 shows a first storage box 10′ with a vertically aligned second storage box 10″. FIG. 14 illustrates a cross-sectional view of the vertically aligned storage boxes 10′, 10″ and FIG. 14A illustrates a closeup of region ‘A’ of FIG. 14 showing the second connector member 260 of the first storage box 10′ in an open position. In the previous figures, the second connector member 260 has been in a storage position from which it can be pivoted. The second connector member 260 has a hook 264 with an enlarged end such that it is in the form of a latch.

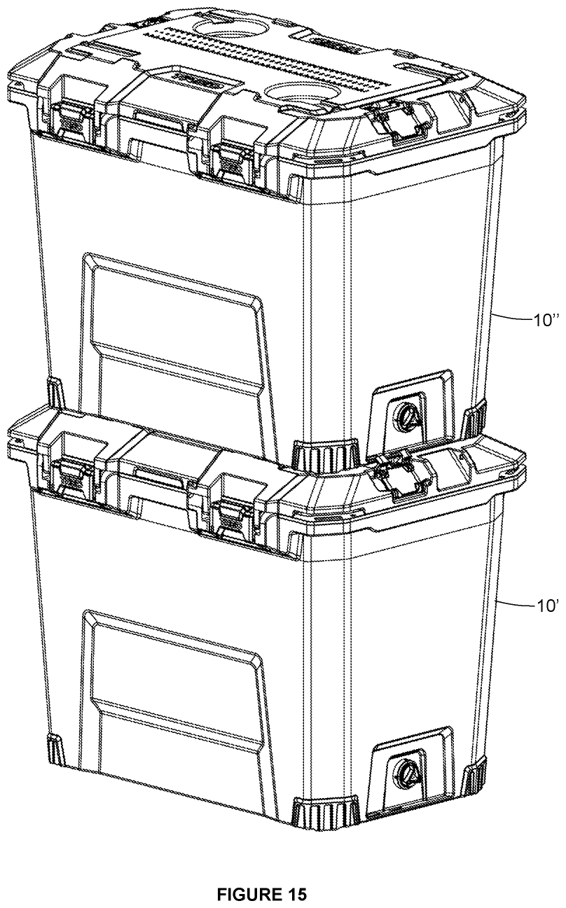

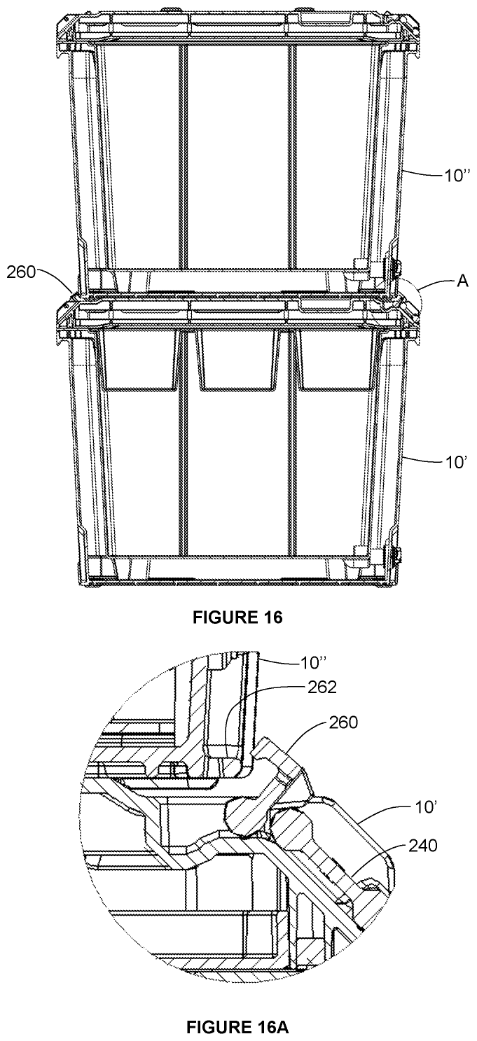

FIGS. 15 to 16A show the storage boxes 10′, 10″ stacked vertically, such that the second storage box 10″ is sitting on top of, and supported by, the first storage box 10′ The lids 200 are profiled such that they correspond to the floor 112 and feet 114 sufficiently to ensure to stable fit between stacked boxes 10′, 10″.

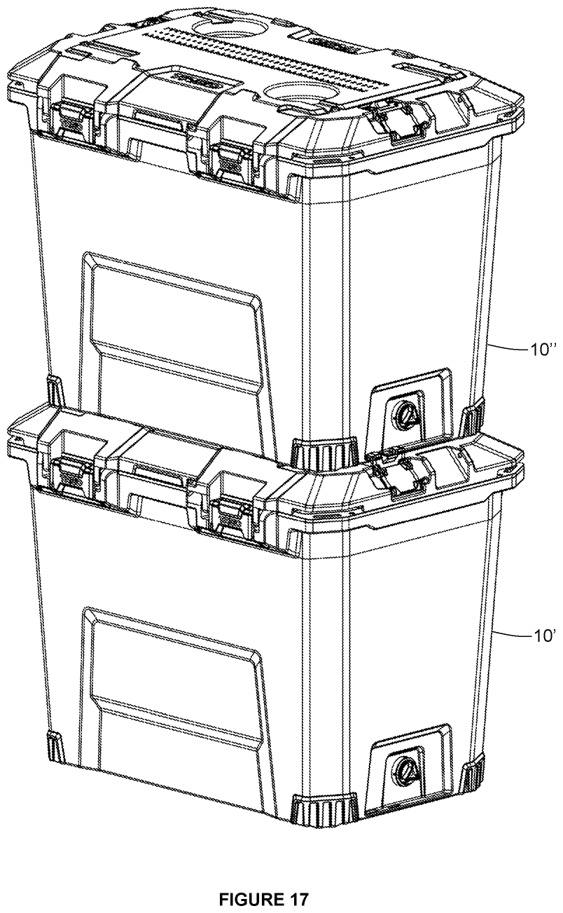

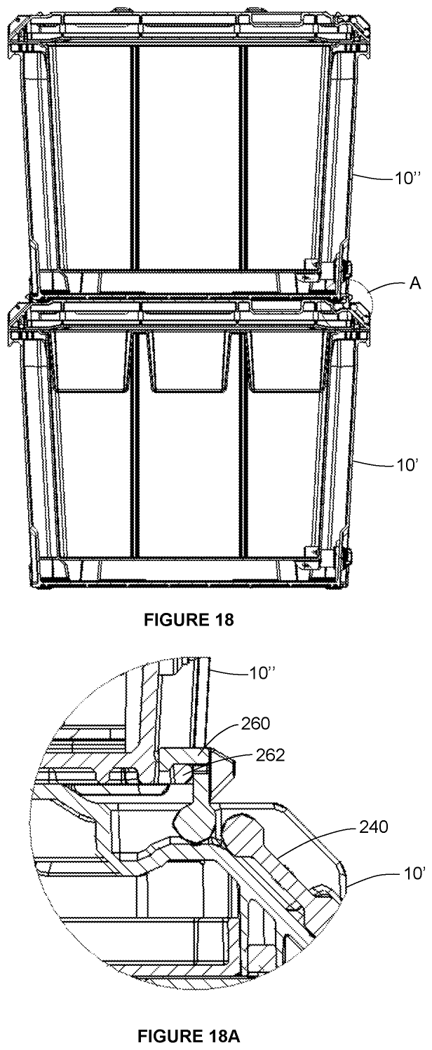

As seen most clearly in FIG. 16A, the second connector 260 is still in the open position meaning the vertically adjacent boxes 10′, 10″ are independent and unconnected. In FIGS. 17 and 18A the second connector 260 is pivoted back towards its storage position where is connects with the rib 262, which effectively forms a catch, of the vertically adjacent storage box 10″ into a connected position.

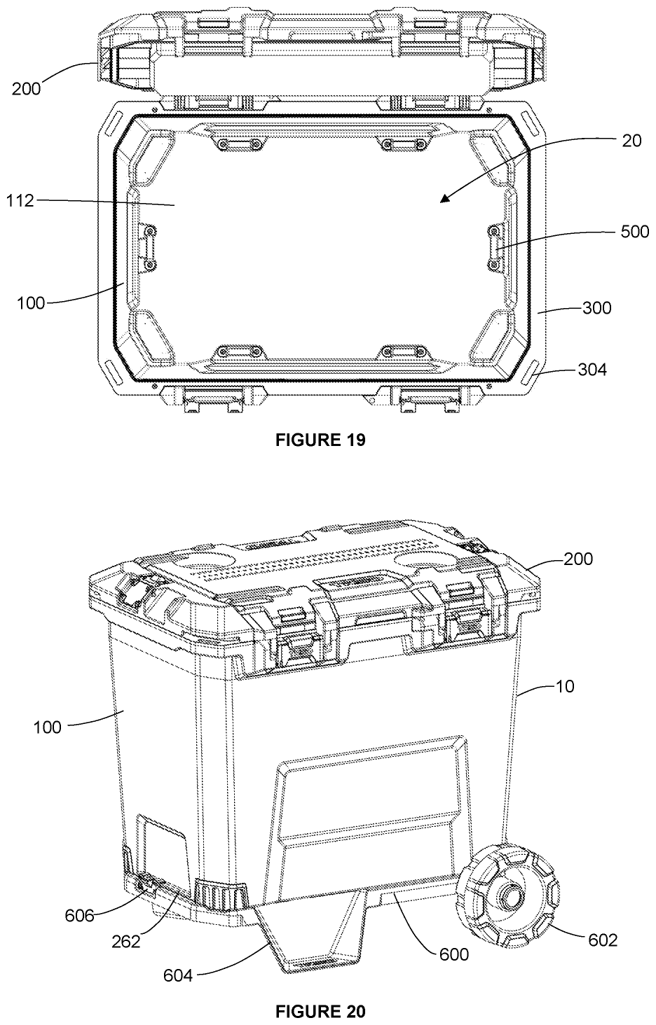

FIG. 19 illustrates the inside of a storage box 10, without liner 400 (although it could optionally be inserted instead of the fascia 300), but having anchor members 500 located on the floor. The anchor members are effectively hoops mounted to plinths on the floor of the box 10 to enable contents to be secured. The tie-down apertures 304 that can receive ropes, straps, or webbing or the like to secure the box 10 are also more clearly visible in this figure.

FIG. 20 illustrates a box 10 with a wheel accessory 600. The wheel accessory 600 has a pair of wheels 602, a stand 604, and a clamp 606 that latches onto the rib 262 of the storage box 10. The wheel accessory may assist with maneuvering heavy loads.

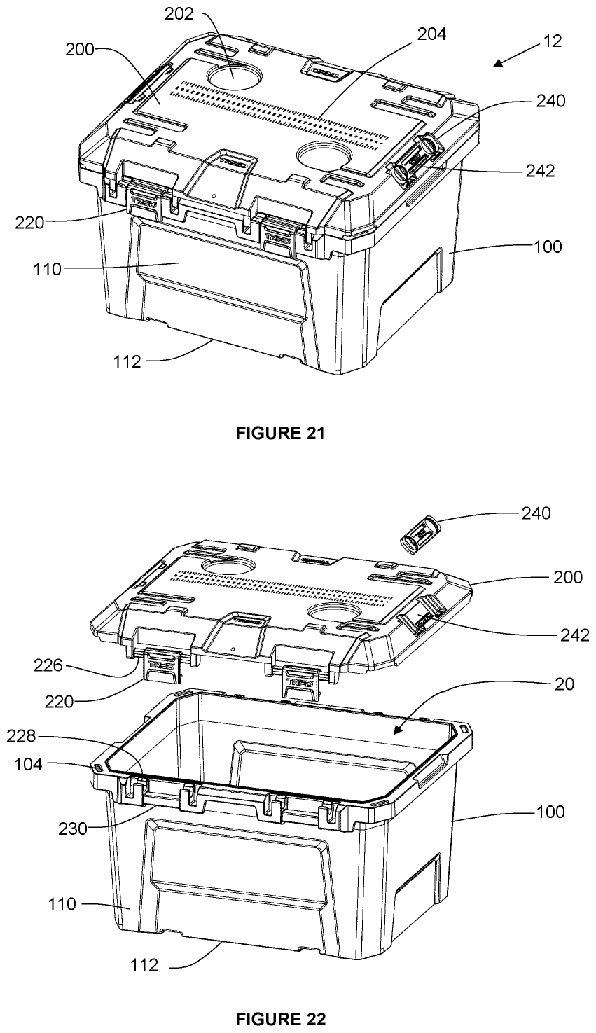

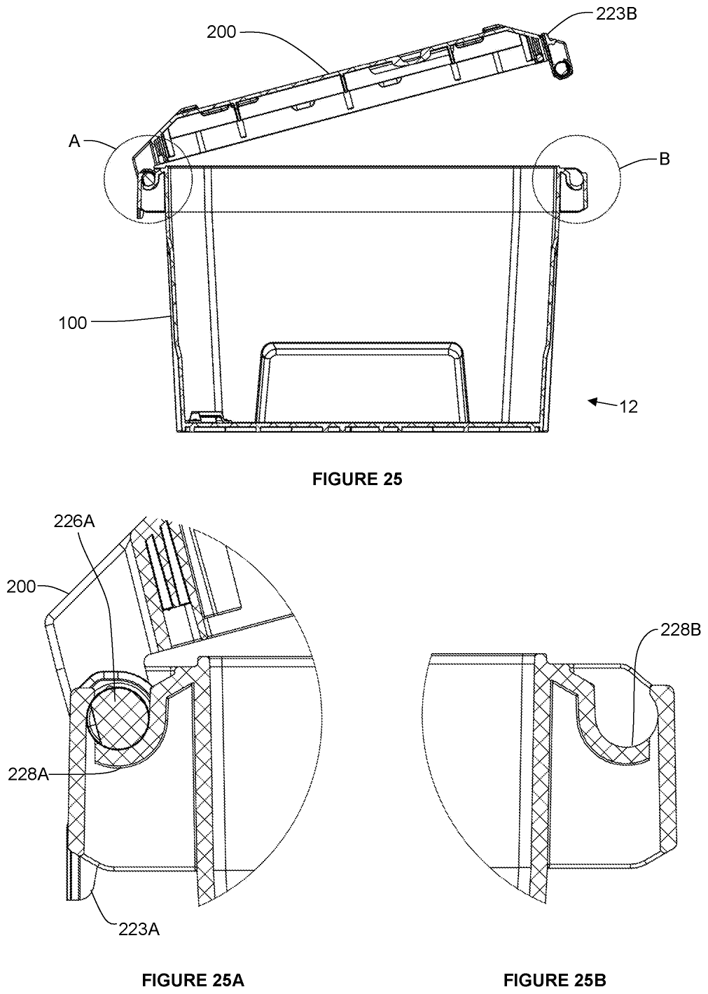

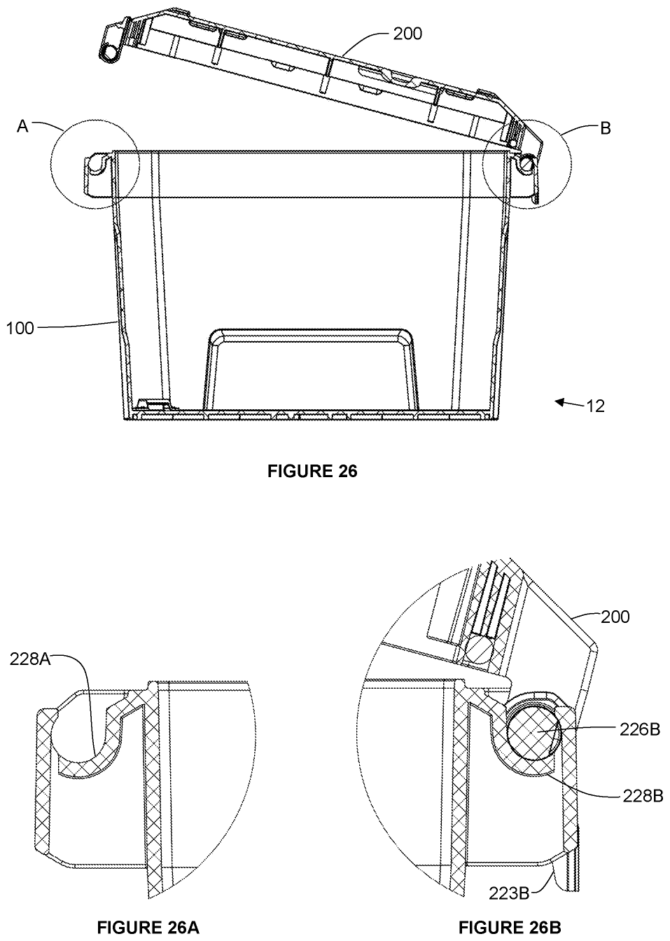

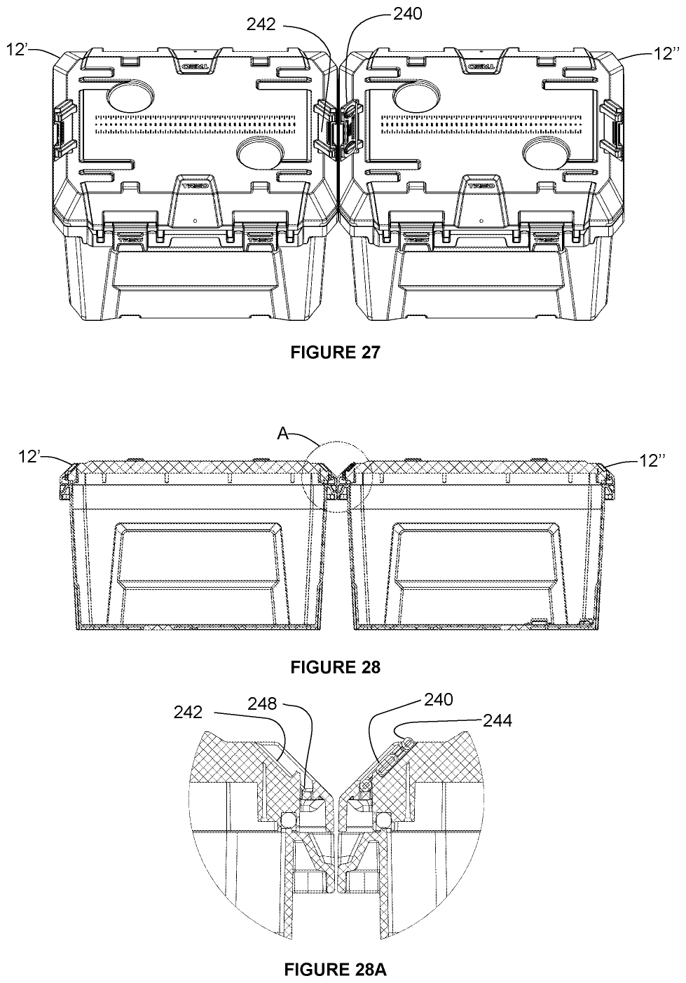

FIGS. 21 to 30A illustrate a storage box 12 according to a different form. It is illustrated without a fascia 300 or liner 400. FIGS. 21 to 30A correspond to FIGS. 3 to 12A and like numbering has been used for consistency. The main difference between storage boxes 10 and 12 is in the hinge members 220.

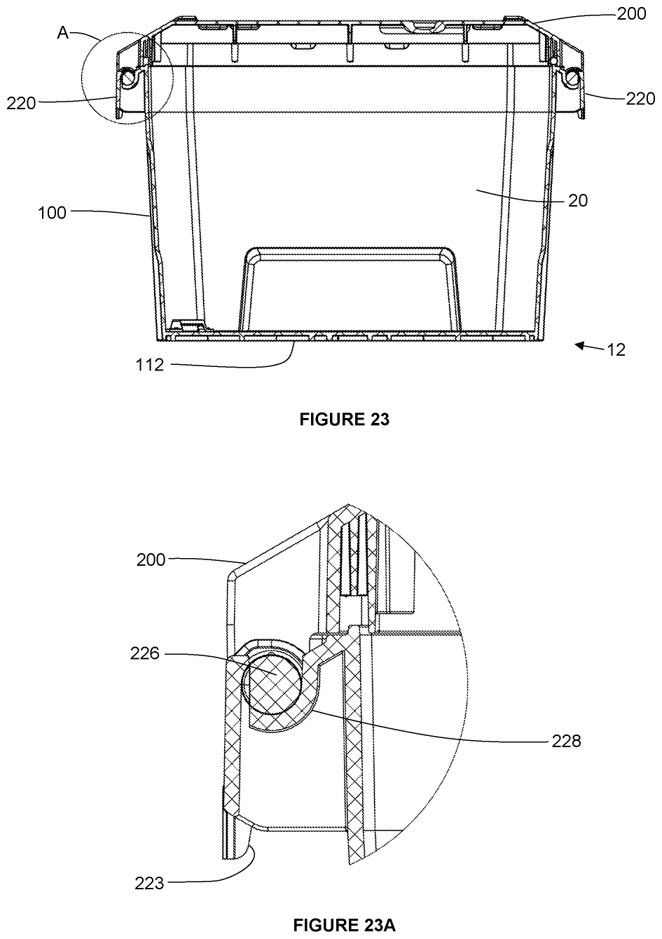

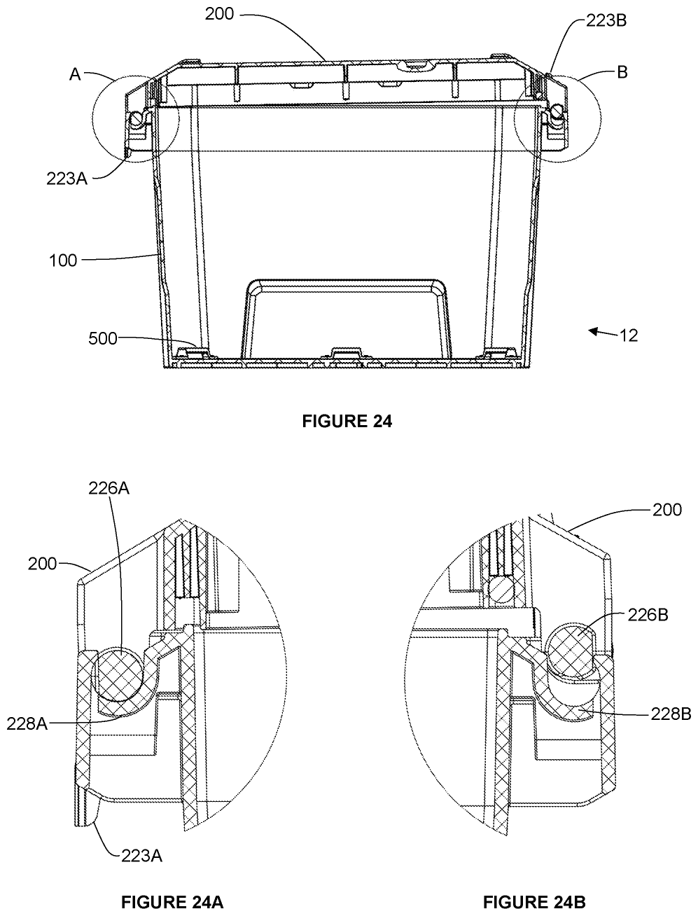

As best seen in FIG. 22, the hinge members 220 of the storage box 12 are pivotally connected to pin 226 of the lid 200. A distal end 223 of the hinge member 220 (relative to the pin) is a clip. When the pin 226 is located in the seat 228, as illustrated in FIGS. 23 and 23A, the hinge member 220 can be locked shut by engaging the clip with a suitably shaped member 230 of the body 100. FIGS. 24 to 26B illustrate the selective hinge mechanism of storage box 12 in use.

Another difference in the storage box 12 is that there are no second connector members 260 and the pockets 248 for first connector members 240 are located at a bottom end of the recess 242. It should be appreciated that just because there are no second connector members 260 does not mean the storage box 12 cannot be stacked vertically.

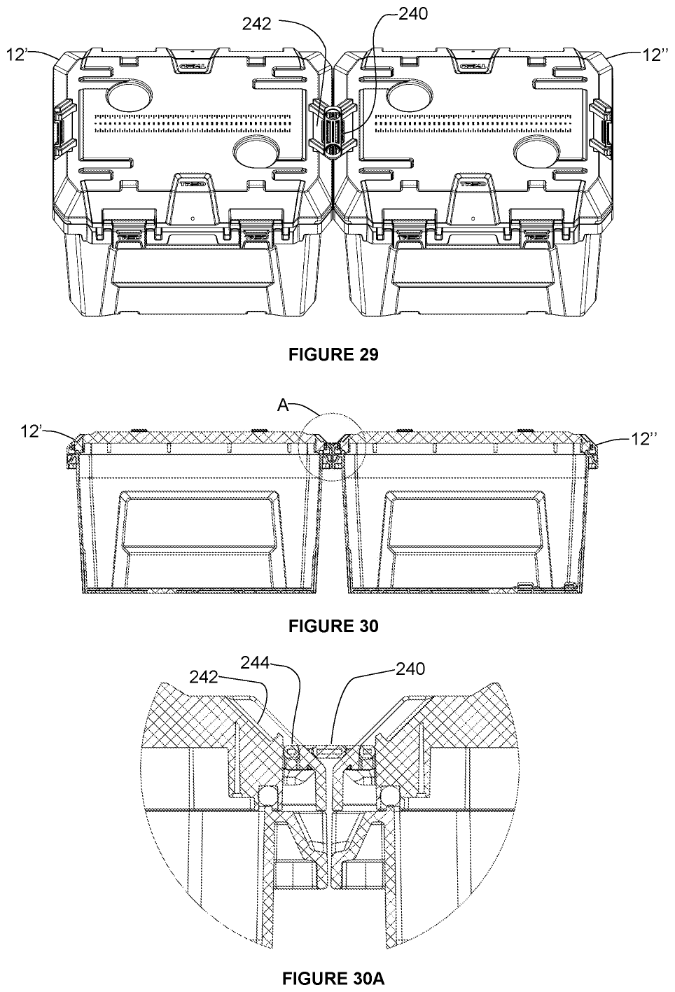

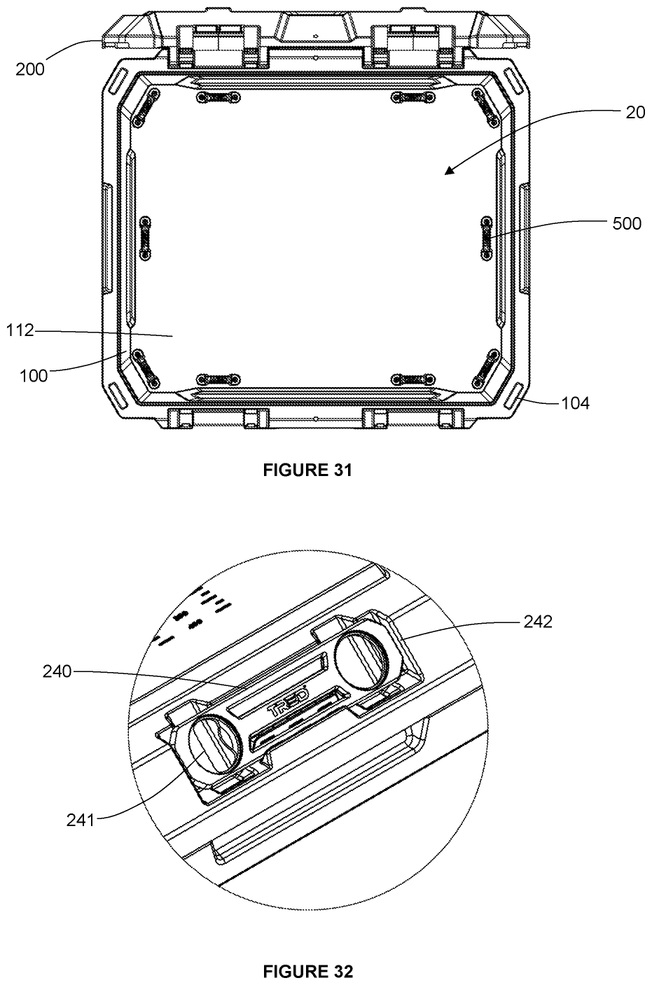

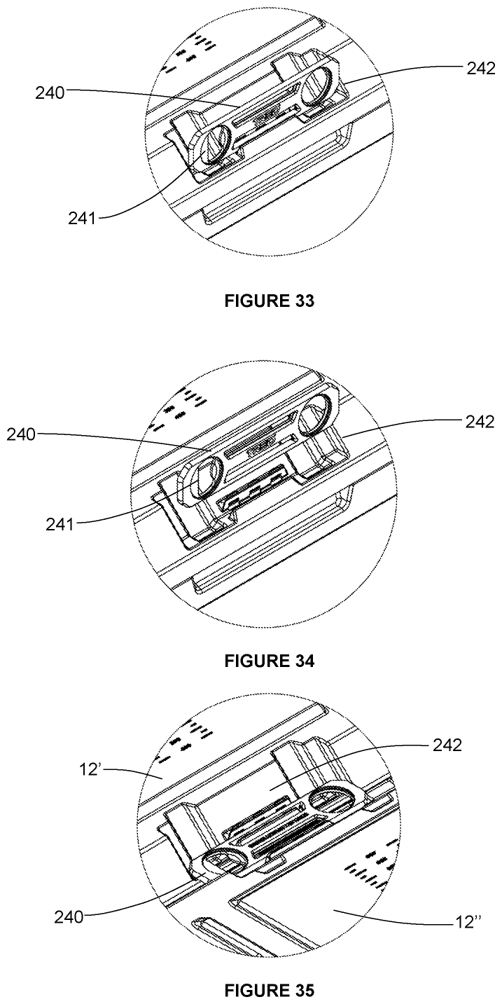

FIGS. 32 to 35 illustrate closeup views of a form of connector 240 in various positions. FIG. 32 illustrates the connector 240 in a storage position located in a recess 242. In FIG. 33 the connector 240 has been pivoted to an upright position. Due to the shape of the connector 240, it may be removed from the recess 242 when in this upright position. FIG. 34 illustrates the connector 240 removed. The connector may comprise one or more tools. For example, the illustrated connector 240 comprises a bottle cap remover 241. Finally, FIG. 35 illustrates the connector 240 when connecting two adjacent storage boxes 12′, 12″ such as also shown in FIGS. 29 to 30A.

Advantageously, the storage box 10 or 12 provides a modular, adaptable, and versatile load carrying apparatus. It can be used as a general storage box or, with the liner 400, as a cooler box. The lid 20 can be opened from whichever side is convenient to the user, or removed altogether. Adjacent boxes can be connected horizontally and, in the case of storage box 10, vertically as needed. Various other improvements are present for the convenience of a user as hereinbefore described.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

In this specification, the terms ‘comprises’, ‘comprising’. ‘includes’, ‘including’, or similar terms are intended to mean a non-exclusive inclusion, such that a method, system or apparatus that comprises a list of elements does not include those elements solely, but may well include other elements not listed.

1. A storage box comprising:
a body defining a cavity for storage of articles therein;
at least one lid configured to selectively allow access to the cavity of the body;
one or more first connectors configured to connect to a horizontally adjacent storage box; and
one or more second connectors configured to connect to a vertically adjacent storage box.

2-3. (canceled)

4. The storage box of claim 1, wherein the one or more first connectors are located on the at least one lid.

5. The storage box of claim 1, wherein the one or more second connectors are located on the at least one lid.

6. The storage box of claim 1, wherein one or both of the first connectors and second connectors comprise latch members configured to be releasably retained by corresponding catches.

7. The storage box of claim 1, further comprising a fascia located around an opening to the cavity in the body; and
wherein the fascia comprises one or more apertures configured to receive one or more of a strap, rope, or webbing.

8. (canceled)

9. The storage box of claim 1, wherein the one or more first connectors comprise a latch member configured to be received by a recess of a horizontally adjacent storage box.

10. The storage box of claim 9, wherein the latch member comprises a protrusion configured to be releasably received by a pocket of the recess of the horizontally adjacent storage box.

10. (canceled)

11. The storage box of claim 1, wherein the one or more second connectors comprise a hook.

12. The storage box of claim 11, wherein the hook is configured to grasp a rib of a vertically adjacent storage box.

13. The storage box of claim 1, wherein the lid is selectively hinged to the body via a plurality of hinge members.

14. The storage box of claim 13, wherein the hinge members comprise a fixed end and a free end.

15. The storage box of claim 14, wherein the hinge members are pivotable between a locked position and an unlocked position.

16. The storage box of claim 15, wherein the hinge members comprise an arm and a gate.

17. The storage box of claim 16, wherein the gate of each hinge member retains a pin of the lid in a seat of the body when the hinge member is in the locked position.

18. The storage box of claim 17, wherein the gate of each hinge member allows the pin of the lid to release from its seat when in the unlocked position.

19. The storage box of claim 13, wherein the hinge members comprise a clip configured to releasably engage with a suitably shaped member of the body.

20. The storage box of claim 1, wherein the lid is selectively openable, and removable, from either side of the body.

21. The storage box of claim 1, further comprising a liner configured to be received into the cavity of the body.

22. The storage box of claim 21, wherein the liner is removable.

23. The storage box of claim 21, wherein the liner is spaced apart from the walls of the body separating the cavity into an inner portion of the cavity located within the liner and an outer portion of the cavity located between the liner and the body.

24. The storage box of claim 21, wherein the liner comprises one or more grooves configured to receive one or more dividing members.

25. The storage box of claim 21, further comprising storage trays suspended in the liner.

26. The storage box of claim 1, further comprising anchoring members in the cavity.

27. The storage box of claim 1, further comprising one or more elastomeric feet.

28. The storage box of claim 1, further comprising a drainage system comprising a drainage hole located in a wall of the body.

29. The storage box of claim 28, wherein the drainage system comprises one or more of a drainage sleeve, a bung, screw cap, and seals.

30-32. (canceled)
